(19) United States
(12) Patent Application Publication
(10) Pub. No.: US 2005/0246949 A1
(43) Pub. Date: Nov. 10, 2005

(54) Biodegradable fibrous support for soil mulching

(76) Inventors: Pierrick Girard, Saint Foy Les Lyon (FR); Jophes Dussaud, Vienne (FR); Laurence Vrevin, Vienne (FR)

Correspondence Address: NIXON & VANDERHYE, PC, 901 NORTH GLEBE ROAD, 11TH FLOOR, ARLINGTON, VA, 22203, US

(21) Appl. No.: 10/524,136

(22) PCT Filed: Aug. 12, 2003
(86) PCT No.: PCT/FI03/00601

§ 371 Date: Mar. 3, 2005

(30) Foreign Application Priority Data
Aug. 13, 2002 (FR) 0210260

(51) Int. Cl. C09K 17/52

(52) U.S. Cl. 47/9

(57) ABSTRACT

Biodegradable fibrous support for soil mulching, characterized in that it is coated with an aqueous solution based on biodegradable natural latex from the rubber tree.

The invention relates to a biodegradable fibrous support for soil mulching, which can be used especially in the field of horticulture, market gardening, landscaping (tree nursery, green spaces).

In the rest of the description, the expression “fibrous support” denotes a support based on coniferous or deciduous unbleached or bleached plant fibres, or fibres of annual plants such as cotton, ramie, jute, flax, hemp etc. or synthetic fibres such as e.g. viscose, these fibres being biodegradable and they can be used by themselves or as a mixture, said support being furthermore able to comprise additives, in a manner that is not exhaustive, such as carbon black, hydrophobic resins (polyamide, epichlorhydrin etc.), fungicide, fungistatic and bactericidal agents, the mass of the support being between 40 g/m² and 200 g/m², advantageously 150 g/m².

The materials for mulching of the soil have to solve a certain number of the following objectives: prevent the weeds from growing shoots, maintain the structure of the soil, control the variations of the climate (moisture, temperature), assure a regular production both quantitatively and qualitatively, and make possible their mechanical application on the ground.

Several types of soil mulching materials are nowadays proposed, among which the plastic films and papers/nonwovens can be distinguished.

Firstly, black plastic sheeting is known, which has the advantage of being solid, despite its low weight per unit area, and thus being weather-resistant. However, this plastic sheeting has a certain number of drawbacks, especially that of not being biodegradable, its lifetime being in the order of 450-600 years. For obvious environmental reasons, plastic cannot be buried in the soil. Consequently, when the harvesting has been completed and the grower wishes to plough his land, he must completely remove the plastic. The cost of this operation is estimated to be 20% of the total cost of the mulching.

Moreover, since the plastic heats up very quickly when exposed to solar rays, the leaves of the plant close to the ground adhere and then burn having as consequences, firstly, the decrease of the productivity because of delayed growth and, secondly, they can only be removed with removal of this film. It is estimated that the removal of one ton of plastic entails the removal of one ton of plants and earth that have remained attached to the said plastic. Consequently, the plastic is virtually unrecyclable, the cost of washing it being unacceptably high for such an operation.

To solve the problem related to biodegradability, attempts have been made to manufacture films based on biodegradable materials, such as polymers of polylactic acid (PLA). In this sense, the document FR-A-2 733 520 describes association of a net or a “spunbund” of PLA with a film based on BAPE (biodegradable aliphatic polymer), i.e. a material from fossil resources (oil or gas) by heat sealing. However, this type of product has the inconvenience of being expensive to produce. Moreover, and above all, the fossil resources last for a limited period and, at least as far as oil is concerned, its reserve is estimated to last about forty years (source BP) in 2000. Accordingly, the use of these materials for mulching of the soil is eventually compromised.

The document FR-A-2813 388 describes a liquid composition based on natural latex and stabilizing agents of latex for protecting the soils. In order to be efficient, the solution is deposited in an amount of 0.3-1 kg/m² as dry matter of latex. This solution has several disadvantages. First of all, the liquid form of the protection means makes it impossible to think of its use on inclined planes, such as slopes.

Papers and nonwovens form another soil mulching category, the mechanical properties of which, especially their tearing strength, are low compared with plastics.

In order to solve this problem, the document JP8205693 describes a mulching paper, the surface of which is covered with a layer of butadiene-styrene latex and paraffin. However, this paper has the inconvenience of not being biodegradable. The document U.S. Pat. No. 5,163,247 describes a similar solution with the same disadvantages.

The document JP8205692 describes in turn a mulching paper made from paper pulp containing fumic acid and an oxyquinoline biocid.

The document JP5103553 describes a kraft paper for soil mulching, the surface of which is coated with silicone. Not only does the silicone contain heavy metals (Pt or Sn) coming from the cross-linked agent but, furthermore, it is not biodegradable because of its inert character.

To solve this problem related to biodegradation, the document JP6062680 describes a paper, one face of which is covered with a solution of carbon black and acrylic resin, whereas the other face is coated with a solution of chitosan. However, the presence of acrylic resin implies that the support is not entirely biodegradable.

To solve this problem, the document FR-A-2 016 071 describes mulching papers treated with urea-formaldehyde resins. However, despite this treatment, the paper can break due to the effect of the watering phases, which expand the paper, and of the drying phases which retighten the paper.

The document WO 01/25536 of the Applicant describes a mulching paper comprising a resin based on epichlorhydrin, the paper being degraded by spraying an enzymatic solution capable of destroying both the resin and the cellulose. However, the described papers are adapted to short growing periods e.g. of the lettuce type. In particular, the mentioned paper based on deciduous fibres (20%), coniferous fibres (50%) and epichlorhydrin resin (3%), sold by the Applicant under the trademark SEQUANA®, has a satisfactory strength during 3-4 months only, thus preventing its use for longer growing periods of e.g. 4-5 months for the melons, 9 months for the strawberries, 2-4 years in the field of tree nursery and green spaces.

In other words, the problem that the invention aims to solve is that of developing a mulching support based on plant fibres, which would be inexpensive, resistant during the relatively long-term growing, in practice in the order of 1-36 months and 100% biodegradable within a time limit as short as possible after said growing has ended and at a low cost.

To do this, the invention proposes a biodegradable fibrous support for the soil mulching, characterized in that it is coated with an aqueous solution based on biodegradable natural latex from the rubber tree, and with stabilizing and preservative agents of the said latex.

Because of its origin, the latex used is natural, i.e. 100% biodegradable, and allows in the same time to efficiently reinforce the mechanical properties of the support. Consequently, the natural latex coming from the rubber tree allows reinforcing the mechanical strength of the support during the whole growing period yet without delaying the degradation process of the plant fibres, which is faster than that of the mentioned latex.

In an advantageous embodiment, the fibrous support of the invention can be advantageously coated with an aqueous solution comprising 5-50% by weight of biodegradable natural latex obtained from the rubber tree, the balance to 100% consisting of water, stabilizing and preservative agents of latex. The synthesis molecules such as bactericides (such as e.g carbendazine, isothiazoline), fungicides or fungistats (such as e.g. potassium sorbate) can also be incorporated into the coating solution, even if for regulation reasons, these substances are more and more avoided.

Among the stabilizers are especially denoted, but in a non limitative manner, the substances chosen from the group comprising the vegetable proteins such as especially casein, soya protein, the mineral fillers such as talc, calcium carbonate, by themselves or as a mixture.

In the list of preservative agents of latex, i.e. of the agents able to avoid the degradation of the latex by the micro-organisms, appear especially the substances chosen from the group comprising the animal proteins such as glycerin, but also the tannins, especially that of mimosa, the natural colouring agent indigo, the chitosan, by themselves or as a mixture. For allowing the fixation of the tannin on the fibrous support, the coating solution contain metallic salts such as e.g. the aluminium sulphate Al₂(SO₄)₃.

It is to be noted that glycerin can be of either vegetable or animal origin.

In practice, the stabilizing agents represent from 1 to 50% by weight of the coating solution. Also, the preservative agents represent from 1 to 30% by weight of the coating solution.

According to another characteristic, the coating solution is coated in an amount of 10 to 200 μm² as dry matter of latex, advantageously between 90 and 100 g/m².

In practice, the latex used is obtained from Hevea Brasiliensis and it has a dry rubber concentration at least of 60%. A latex corresponding to this definition is, for example, the one sold under the trademark ALCANTEX® by the company SAFIC-ALCAN.

Instead of natural latex, the fibrous support of the invention can be advantageously coated with an aqueous solution comprising 5-50% by weight of biodegradable prevulcanized natural latex obtained from the rubber tree. Prevulcanized natural latex is, for example, sold under the trademark REVULTEX MR® by the company SAFIC-ALCAN.

The prevulcanized natural latex can be made biodegradable by utilizing sulphur-eating bacteria, like sulfolobus acidocaldarius, for example by adding the bacteria with the prevulcanized natural latex fibrous support. Besides being biodegradable, the prevulcanized natural latex is easier to handle, for example a lifetime is longer if required.

In a particular embodiment, the coating solution consists, by weight, of:
from 5 to 50%, advantageously from 15 to 25%, biodegradable natural latex obtained from the rubber tree,
from 1 to 20%, advantageously from 5 to 10%, vegetable proteins,
from 0 to 20%, advantageously from 5 to 10%, talc,
from 0.1 to 1%, advantageously 0.5%, biocide,
the balance to 100% consisting of water.

In an advantageous embodiment, the biocides represent from 1 to 20% by weight of the solution and are composed of chitosan and/or indigo, and/or glycerin, and/or tannin, by themselves or as a mixture.

In practice, the fibrous support is coated with a latex-based solution by a size press after the fibrous support has been obtained. The spreading method can also vary according to the production means and the use of a coating machine, a spraying, impregnation or any other depositing device is also acceptable.

Moreover, for mechanically reinforcing the mulching support even more, the said support may further contain thermobonding biodegradable synthetic fibres representing 5-50%, advantageously 10-15%, by weight of the support.

In the rest of the description and in the claims, the expression “thermobonding fibres” denotes short fibres having a size of between 1 and 30 mm, preferably in the order of 5 mm, the average melting point of which is between 60° C. and 180° C., these fibres being able to melt during the manufacturing process of the support so as to bind the fibres nearby and to strengthen the mechanical properties of the said support. In practice, the fibres are chosen so that they melt at the temperature, at which the support is manufactured, which is about 100° C. if the support is manufactured on a paper machine and about 170° C. if the support is manufactured on a nonwoven machine.

The thermobonding fibres of the invention may have a unique or double melting point on the assumption that the fibre is in the form of a so-called “bicomponent” fibre, corresponding to a fibre comprising two polymers having distinct physical and/or chemical characteristics, extruded from the same die for forming a single filament. In other words, the fibre in is the form of a core, having a first melting point surrounded by a sheath having a second lower melting point. This is e.g. the case with PLA (polylactic acids) fibres sold by UNITKA under the trademark TERRAMAC®, especially under the reference PL80, the core and sheath melting points of which are equal to 170° C. and 130° C., respectively.

In order to still reinforce the support, it may be provided with a grid, which is either maintained on the whole part of at least one face of the support, or incorporated into the whole or part of the mass of the support.

In the rest of the description and in the claims, the expression “grid” denotes a grid formed by a network of crossed non-woven threads comprising at least two webs of warp and weft threads, these warp and weft threads being interconnected at their crossings by a bonding agent creating a series of gluing points. This type of a grid and its manufacturing process are described e.g. in the document EP-A-1 111 114.

In practice, the grid is produced of biodegradable polymers chosen from the group comprising polylactic acid, polycaprolactone, viscose, modified viscose such as of the LYOCELL or MODAL type, polyhydroxybutyrate and polyhydroxyalcanoate, by themselves or as a mixture. In an advantageous embodiment, the grid is produced exclusively of modified viscose threads and corresponds e.g. to the grid sold by CHAVANOZ INDUSTRIE under the reference 4032/71. According to another embodiment, the grid is produced solely from polylactic acid fibres such as those sold e.g. under the trademark TERRAMAC® by the company UNITIKA.

In practice, the grid has a weight of between 10 and 50 g/m², advantageously in the order of 20 g/m².

According to a first embodiment of the invention, the grid is maintained on the whole surface of the support, on at least one of the both faces according to preference, the grid being able to be placed facing either the soil or the sky. In this case, the mulching will be more particularly adapted to long growing of several months.

In a more economical second embodiment, the grid is placed exclusively in the area of fixing points of the support in the soil, i.e. in the area of air/ground/substrate interface. The Applicant has in fact noticed that the micro organisms in the soil degraded the support and had an important effect on its strength at the fixing points, making it especially sensitive to the weather, especially to the wind. The fitting of the grid in the area of these fixing points, on one or both of the support faces, thus allows slowing down its biodegradation at the points that are sensitive, yet without affecting this process, which is slower, on the part which is not buried.

In practice, the grid is glued directly against the surface of the finished fibrous support by means of biodegradable water-resistant glue chosen from the group comprising ethylene polyvinylic alcohol (EVOH) and polyvinylic alcohol (PVA), by themselves or as a mixture. In practice, the glue represents between 5 and 50%, advantageously 15%, by weight of the grid.

Moreover and according to another characteristic, the support may be subjected to a lime sludge/micrite coating step before or after gluing of the grid.

In a third embodiment, the grid is not glued but directly integrated into the mass of the support during the manufacturing process of the latter. Here again, the grid may be arranged over the whole surface of the support or exclusively in the area of the fixing points of the support on the ground. In practice, the grid is unrolled directly on the fibrous support during formation on the wire of the paper machine or non-woven machine, the grid in the finished product thus being entangled to the surface of the support. Furthermore, with this technique, glue is no longer needed.

When the grid is glued against the surface of the support, the coating of the support by the latex-based solution from the rubber tree can be carried out before or after the fixing of the grid. In any case, whether the grid is incorporated during the manufacturing process or glued, the coated material obtained can be subjected to a lime sludge/micrite coating step, that is to say to dry creping.

According to another characteristic, the fibrous support may contain a hydrophobic resin representing 0.5-15%, advantageously 6-8%, by weight of the support, chosen from the group comprising urea-formaldehyde resins, melamine-formaldehyde resins, polyamide-amine-epichlorhydrin resins, polyethyleneimine resins, starch derivatives, by themselves or as a mixture.

In the same way, depending on the colour of the fibres used, the support may further comprise carbon black representing 0.5-4% by weight of the support.

The latex-based coating from the rubber tree, possibly in the presence of individual thermobonding fibres distributed within the support and/or the grid based on biodegradable material, allows to maintain the mechanical resistance of the support during the whole growing period, yet without affecting the actual degradation process of plant fibres making up the said support. However, this actual degradation process of the support is directly dependent on its composition. In other words, the problem is how to define support compositions according to the desired growing periods.

Consequently and in a first embodiment, the support fibre composition denoted hereinafter “support 1” is as follows:
from 40 to 100%, advantageously from 70 to 90%, by weight of coniferous unbleached or bleached kraft fibres,
from 0 to 60%, advantageously from 10 to 30%, of deciduous unbleached or bleached kraft fibres,
   grammage: from 40 to 200 g/m², advantageously from 55 to 75 g/m².

This type of fibrous composition will be especially suitable for short growing periods from about 1 to 6 months.

In a second embodiment, the fibre support composition denoted hereinafter “support 2” is as follows:
from 80 to 100% by weight of annual plant fibres,
from 0 to 20%, advantageously from 5 to 15%, by weight of coniferous unbleached or bleached kraft fibres.
grammage: from 40 to 200 g/m², advantageously from 90 to 100 g/m².

The fibres from annual plants can come from all types of annual plants rich in fibres, which can be used in paper mills and in the filed of non-woven e.g. of the cotton, ramie, jute, flax, hemp etc. type. In an advantageous embodiment, the fibrous composition contains only fibres that come from annual plants.

This type of fibrous composition will be especially suitable for longer growing periods from about 6 to 18 months.

In a third embodiment, the fibre support composition denoted hereinafter “support 3” is as follows:
from 20 to 100% by weight of coniferous bleached kraft fibres, advantageously from red cedar wood-oil,
from 0 to 40%, advantageously 20-30%, by weight of fibres from annual plants,
from 0 to 40%, advantageously from 20 to 30%, by weight of rayon or viscose fibres.
grammage: from 40 to 200 g/m², advantageously 100 g/m².

In practice, the supports are manufactured on a nonwoven machine, and then bound by mechanical and/or hydraulic needling. The support can also be manufactured by a carding process and then bound by a mechanical and/or hydraulic needling process.

In an advantageous embodiment of the support 3, the fibrous composition further contains a very small amount of bactericide carbon fibres, that is to say carbon fibres doped with silver salts, in the order of 0.5-2% by weight.

This type of fibrous composition will be especially suitable for longer growing periods from about 18 to 36 months.

The invention and the advantages which stem therefrom will become more apparent from the following illustrative examples.

### EXAMPLE 1

A support with the following composition, by dry weight, was prepared:
93% of fibre suspension comprising 100% by weight of coniferous unbleached kraft fibres
3% of epichlorhydrin resin
4% of carbon black
grammage: 75 g/m²

A sheet is formed on a paper machine from all constituents of the support. When the sheet has been formed and dried, it is coated in a size press with a solution comprising, by weight, of:
50% natural latex sold under the trademark ALCANTEX® by the company SAFIC-ALCAN
5% proteins,
10% talc,
1% biocide,
34% water.
   Finally, the coated support obtained is dried

### EXAMPLE 2

The same procedure as for the support 1 was produced, with the exception that the fibre suspension comprises 100% by weight of annual plant fibres (cotton, ramie, jute, flax, hemp).

### EXAMPLE 3

A support with the following composition, by dry weight, was produced:
93% of fibre suspension comprising:
   50% by weight of coniferous bleached kraft fibres, red cedar wood-oil
   25% by weight of annual plants (cotton, ramie, jute, flax, hemp)
   25% by weight of rayon fibres
3% of epichlorhydrin resin
4% of carbon black
grammage: 100 g/m²

A sheet in formed on a paper machine from all constituents of the support. The sheet to be formed is subjected to a hydraulic entanglement step known by the name JETLACE. Once the sheet is formed and dried, it is coated in a size press with a solution consisting (by weight) of:
50% natural latex sold under the trademark ALCANTEX® by the company SAFIC-ALCAN
5% proteins,
10% talc,
1% biocide,
34% water.
   Finally, the coated support obtained is dried.

### EXAMPLE 4

For each of the examples 1-3, prior to the coating phase with a latex-based solution, a modified viscose grid sold by CHAVANOZ INDUSTRIE under the reference 4032/71 is unrolled on the sheet to be formed.

### EXAMPLE 5

The examples 1-4 were repeated by incorporating 20% by weight of PLA-fibres, the average size of which is of 5 mm, sold by UNITIKA under the trademark TERRAMAC® under the reference PL80 to the detriment of the fibre suspension.

1-18. (canceled)

19. A biodegradable fibrous support for mulching of the soil for long-term growing periods of up to 36 months, said fibrous support being coated with an aqueous solution comprising biodegradable natural latex, characterized in that the aqueous solution comprises from 5 to 50% by weight of biodegradable natural latex obtained from rubber tree, the balance to 100% including water, and stabilizing and preservative agents of said latex, the solution forming, on the support, a coating of 10 to 200 g/m2 as dry matter of latex, advantageously from 90 to 100 g/m2, said preservative agents being chosen from the group comprising animal or vegetable proteins, such as glycerin; or chitosan, or tannins or indigo by themselves or as a mixture.

20. A support according to claim 19, characterized in that said natural latex is prevulcanized.

21. A support according to claim 19, characterized in that the natural latex is obtained from Hevea Brasiliensis and has a dry rubber concentration of at least of 60%.

22. A support according to claim 19, characterized in that the stabilizing agents are chosen from the group comprising the vegetable proteins, such as casein, tannins or indigo or soy protein or glycerin; or the mineral fillers, such as talc or calcium carbonate; by themselves or as a mixture.

23. A support according to claim 19, characterized in that the coating solution consists, by weight, of:
from 5 to 50%, biodegradable natural latex obtained from rubber tree,
from 1 to 20%, proteins,
from 0 to 20%, talc,
from 1 to 20% of chitosan, and/or indigo, and/or glycerin, and/or tannins,
the balance to 100% consisting of water.

24. A support according to claim 19, characterized in that it contains thermo-bonding fibres representing from 5 to 50%, advantageously between 10 and 15%, by weight, of the support.

25. A support according to claim 24, characterized in that the thermo bonding fibres are exclusively composed of polylactic acid fibres.

26. A support according to claim 19, characterized in that it is provided with a grid, which is either maintained on the whole or part of at least one face of the support, or incorporated into the whole or part of the mass of the support, said grid being produced of a biodegradable polymers chosen from the group comprising polylactic acid, polycaprolactone, viscose, modified viscose, polyhydroxybutyrate and polyhydroxyalcanoate, by themselves or as a mixture.

27. A support according to claim 26, characterized in that the grid is made exclusively of modified viscose threads.

28. A support according to claim 26, characterized in that the weight of the grid is between 10 and 50 g/m2, advantageously in the order of 20 g/m2.

29. A support according to claim 26, characterized in that the grid is positioned exclusively in the area of the fixing points of the support on the ground.

30. A support according to claim 26, characterized in that the grid is glued directly on the surface of the fibrous support by means of a water-resistant biodegradable glue chosen from the group comprising ethylene polyvinylic alcohol (EVOH) and polyvinylic alcohol (PVA), by themselves or as a mixture, the glue representing between 5 and 50%, advantageously 15%, by weight of the grid.

31. A support according to claim 26, characterized in that the grid is unrolled directly on the fibrous support during its manufacture.

32. A support according to claim 19, characterized in that it it contains a hydrophobic resin representing from 0.5 to 15% by weight of the support, chosen from the group comprising urea-formaldehyde resins, melamine-formaldehyde resins, polyamide-amine-epichlorhydrin resins, polyethyleneimine resins, starch derivatives, by themselves or as a mixture.

33. A support according to claim 19, characterized in that it contains carbon black representing from 0.5 to 4% by weight of the support.

34. A support according to claim 19, characterized in that the fibre composition of the support is as follows:
from 40 to 100%, advantageously from 70 to 90%, by weight of coniferous unbleached or bleached kraft fibres;
from 0 to 60%, advantageously from 10 to 30%, by weight of deciduous unbleached or bleached kraft fibres.

35. Support according to claim 19, characterized in that the fibre composition of the support is as follows:
from 80 to 100% by weight of annual plant fibres,
from 0 to 20% by weight of coniferous unbleached or bleached kraft fibres.

36. Support according to claim 19, characterized in that the fibre composition of the support is as follows:
from 20 to 100% by weight of coniferous bleached kraft fibres,
from 0 to 40% by weight of annual plant fibres,
from 0 to 40% by weight of rayon fibres.
